(19) United States
(12) Patent Application Publication
(10) Pub. No.: US 2019/0335541 A1
(43) Pub. Date: Oct. 31, 2019

(54) TEMPERATURE CONTROL DEVICE WITH PTC MODULE

(71) Applicant: Mahle International GmbH, Stuttgart (DE)

(72) Inventors: Eric Marlier, Kolbsheim (FR); Pascal Miss, Selestat (FR); Jerome Stoeckel, Bollwiller (FR); Falk Viehrig, Stuttgart (DE)

(21) Appl. No.: 16/396,229

(22) Filed: Apr. 26, 2019

(30) Foreign Application Priority Data
Apr. 27, 2018 (EP) 18169852.3

(51) Int. Cl. H05B 1/02

(52) U.S. Cl. CPC H05B 1/0297; H05B 2203/02

(57) ABSTRACT

A PTC module for a temperature control device may include at least one PTC element, having a flat element cross section transverse to a longitudinal direction, and two large outer surfaces along the longitudinal direction facing away from each other, and two small outer surfaces facing away from each other and joining together the two large outer surfaces. The PTC module may also have an envelope body enclosing the PTC element at least in a circumferential direction, two electrical conductors extending in the longitudinal direction and spaced apart from each other in the flat element cross section and electrically conductively connected to the PTC element, and two electrically isolating insulator plates extending in the longitudinal direction and each of which may be connected in a heat transfer manner to one of the large outer surfaces. Each electrical conductor may be formed by an electrically conducting conductor coating on a respective one of the insulator plates, where one conductor coating may be arranged on one insulator plate only in a first edge region, which borders on one small outer surface, and the other conductor coating may be arranged on the other insulator plate only in a second edge region, which borders on the other small outer surface.

### CROSS-REFERENCE TO RELATED APPLICATION

This application claims priority to European Patent Application No. 18169852.3, filed Apr. 27, 2018, which is hereby incorporated by reference in its entirety.

### TECHNICAL FIELD

The present invention relates to a PTC module for a temperature control device, having at least one PTC element. The invention furthermore relates to a temperature control device with one or more such PTC modules.

### BACKGROUND

Temperature control devices are used for controlling the temperature of a fluid or an object. The term “temperature control” basically subsumes a heating, or supplying of heat, and a cooling, or removal of heat. For the generating of heat and thus the heating in the temperature control device it is known to use PTC elements, which have an increasing electrical resistance with rising temperature. Such PTC elements are also known as cold conductor elements, and PTC stands for Positive Temperature Coefficient. Such PTC elements are advantageous in particular on account of their self-regulating property. Generally a plurality of such PTC elements are assembled into PTC modules, the respective PTC module usually having a series of PTC elements, to which an electrical voltage is applied during operation, in order to generate heat inside the respective PTC element. In order to apply such an electrical voltage, electrical conductors are needed, being electrically conductively connected in suitable manner to the respective PTC element.

For manufacturing technology reasons, PTC elements with flat element cross sections are especially economical to produce. Furthermore, the PTC elements are preferably flat, which likewise favours an economical production. The flat element cross section extends transversely to a longitudinal direction of the element or, in the installed state, transversely to a longitudinal direction of the module. The flat element cross section means that the respective PTC element has two large outer surfaces and two small outer surfaces along the element longitudinal direction and along the module longitudinal direction. The two large outer surfaces face away from each other. The two small outer surfaces are also facing away from each other. The two small outer surfaces join the two large outer surfaces together.

The flat element cross section has two long or large outer sides and two short or small outer sides, which join together the two large outer sides. The large outer sides in the element cross section lie in the large outer surfaces of the PTC element, while the small outer sides in the element cross section lie in the small outer surfaces of the PTC element. By a “flat” element cross section is meant a cross section in which the large outer sides are at least twice as large as the small outer sides. Preferably, the large outer sides are at least five times larger than the small outer sides.

For the electrical contacting of such flat, especially block-shaped PTC elements it is basically possible to electrically connect the two electrical conductors to the two large outer surfaces. However, this impairs the heat transfer, from the PTC elements to the outside, which should expediently occur through the large outer surfaces. Furthermore, this increases the module thickness, which is measured in the direction of the spacing between the large outer surfaces. A distinctly more compact design can be achieved, on the other hand, if the electrical conductors are electrically conductively connected to the two small outer surfaces. The electrical contacting in the region of the small outer surfaces furthermore means that electric current flows through the respective PTC element in its width direction, so that a distinctly longer electricity pathway occurs than when current flows in the thickness direction. The longer the electricity pathway, the more efficient is the transformation of electric current into heat, i.e., the thermoelectric conversion. At the same time, a good heat transfer across the large outer surfaces is also realized in this design. However, the problem with this design is that the positioning of the electrical conductors along the small outer surfaces involves a large manufacturing expense.

### SUMMARY

The present invention deals with the problem of indicating an improved design for a PTC module of the above described kind or for a temperature control device outfitted with such a module, distinguished by a compact design and economical manufacturing possibility.

This problem is solved according to the invention by the subject matter of the independent claim. Advantageous embodiments are the subject matter of the dependent claims.

The invention is based on the general notion of realizing the respective electrical conductor in the form of an electrically conducting coating, which is placed each time on an electrically isolating insulator plate, wherein the respective insulator plate extends in the module longitudinal direction and in each case is connected in heat transfer manner to one of the large outer surfaces of the respective PTC element. Such an electrically conducting conductor coating is applied only slightly in the thickness direction of the respective insulator plate, so that the module thickness overall is changed little if at all. Furthermore, in order to make possible an efficient transformation of electric energy into heat, it is furthermore proposed that the one or first conductor coating is arranged on the one or first insulator plate only in a first edge region of the first insulator plate, this first edge region bordering on the one or first small outer surface of the respective PTC element. On the other hand, the other or second conductor coating is arranged on the other or second insulator plate only in a second edge region, this second edge region bordering on the other or second small outer surface of the respective PTC element. In other words, although in the design proposed here the conductors are arranged as conductor coatings on the insulator plates, which in turn are arranged on the large outer surfaces of the respective PTC element, the conductor coatings in the edge regions are situated next to the small outer surfaces of the respective PTC element facing away from each other. In order for the electric current to flow from the first conductor coating in the first edge region to the second conductor coating in the second edge region, it must flow almost diagonally through the respective PTC element, resulting in a comparatively large electrical pathway inside the respective PTC element, making possible an efficient conversion of the electric current into heat. The design presented here thus combines easy manufacturing possibility with a compact design and high efficiency.

According to one advantageous embodiment, the two conductor coatings may have a spacing in the element cross section along the large outer surfaces which is larger than an element thickness of the respective PTC element measured between the large outer surfaces. Preferably, said spacing is at least twice as large, especially at least three or four times as large, as the element thickness. The larger this spacing is, the longer is the path of electricity flow inside the respective PTC element and the higher the efficiency of the thermoelectric conversion.

Another embodiment proposes that the respective conductor coating has in the element cross section a conductor width measured along the respective large outer surface which is less than 50%, preferably less than 25%, of an element width of the respective PTC element, measured between the small outer surfaces. This provision also results in an enlarging of the electrical pathway inside the respective PTC element, which increases the efficiency of the conversion of electric energy into heat.

Another embodiment proposes that the respective conductor coating has in the element cross section a conductor width measured along the respective large outer surfaces that is larger than an element thickness of the respective PTC element measured between the large outer surfaces. In this way, more electrical contact surface is available than with a traditional lateral electrical contacting solely via the small outer surfaces. Accordingly, more electric power can be supplied.

Basically, the large and small outer surfaces of the respective PTC element may be curved. Especially advantageous, however, is an embodiment in which the large outer surfaces are flat and run parallel to each other. Optionally, the small outer surfaces may also be flat and run parallel to each other. The flat small outer surfaces then extend expediently perpendicular to the flat large outer surfaces, so that the respective PTC element then has a rectangular element cross section. Such flat PTC elements can be produced especially economically in large piece lots.

According to another advantageous embodiment, the respective PTC element may have an electrically conducting metal coating on the respective large outer surface at least in the region of the respective conductor, which is electrically conductively connected to the respective conductor coating. In this way, the electrical contacting between the respective electrical conductor and the PTC element can be improved. Usually the PTC element consists of a ceramic body.

Especially advantageous is a modification in which the respective conductor coating is soldered to the respective metal coating. This creates an especially good electrical contacting. Alternatively, a glue connection between the insulating plates and the respective PTC element is also basically conceivable, which likewise produces a sheetlike contacting between the respective conductor coating and the respective large outer surface of the PTC element. The adhesive then expediently does not cover the respective conductor coating.

Expediently, the module may comprise a plurality of such PTC elements, arranged in succession in the module longitudinal direction. An envelope body of the module is expediently associated with all of the PTC elements of the module, so that it encloses all of the PTC elements in the circumferential direction. The circumferential direction runs in this case around the longitudinal centre axis of the module. Moreover, it may be provided that the two insulator plates extend across all PTC elements, so that the two conductor coatings are electrically conductively connected to all the PTC elements. In this way, a module can be created with a plurality of PTC elements that requires only a few individual parts and is therefore economical to produce.

Expediently, the respective insulator plate may be thermally conductive and be connected in sheetlike and heat transfer manner by a plate outer side facing away from the respective PTC element to a body inner side of the envelope body facing toward the respective PTC element. It is conceivable here, on the one hand, to have a direct contacting between the respective insulator plate and the envelope body. Also conceivable is the use of thermally conductive pastes or thermally conductive films by which the thermal connection between the respective insulator plate and the envelope body can be produced.

Another embodiment proposes that the envelope body is connected in heat transfer manner to cooling fins at least on one body outer side facing away from the respective PTC element. Such cooling fins enlarge the surface for contacting and heat transfer to a fluid flowing around the respective module. The fluid, whose temperature is to be controlled with the aid of the respective PTC module or with the respective temperature control device, can basically constitute a liquid. Preferably, however, this constitutes a gas, especially air.

A temperature control device according to the invention which is to be used to control the temperature of a fluid and which should be used in particular in a motor vehicle comprises at least one PTC module of the abovedescribed kind as well as a control device for the electrical actuation of the respective PTC module.

Advantageous is one embodiment of the temperature control device comprising a plurality of such PTC modules, which are arranged alongside each other in a heat transfer region through which the fluid whose temperature is to be controlled can flow. The temperature control device thus forms a flow-type heat exchanger, which can be used for example in an air conditioning system of a motor vehicle.

Another embodiment proposes that a plurality of such PTC modules form a heat transfer block in the heat transfer region, which extends in particular transversely to the principal flow direction of the fluid, and on which the control device is mounted at the side. In particular, the control device is thus located outside the heat transfer region.

Further important features and benefits of the invention will emerge from the dependent claims, from the drawings, and from the corresponding description of the figures with the aid of the drawings.

Of course, the features mentioned above and those yet to be discussed below may be used not only in the respective indicated combination, but also in other combinations or standing alone, without leaving the scope of the present invention.

### BRIEF DESCRIPTION OF THE DRAWINGS

Preferred exemplary embodiments of the invention are represented in the drawings and shall be discussed more closely in the following description, where the same reference numbers pertain to the same or similar or functionally equal components.

There are shown, each time schematically,

FIG. 1 an isometric view of a temperature control device with a plurality of PTC modules,

FIG. 2 an isometric view of a single PTC module with an envelope body and two insulator plates,

FIG. 3 an isometric view of the PTC module of FIG. 2, but omitting the envelope body and one of the insulator plates,

FIG. 4a cross section of the PTC module along sectioning lines IV in FIG. 2, where in addition there are arranged on the envelope body cooling fins which are absent from FIG. 2.

### DETAILED DESCRIPTION

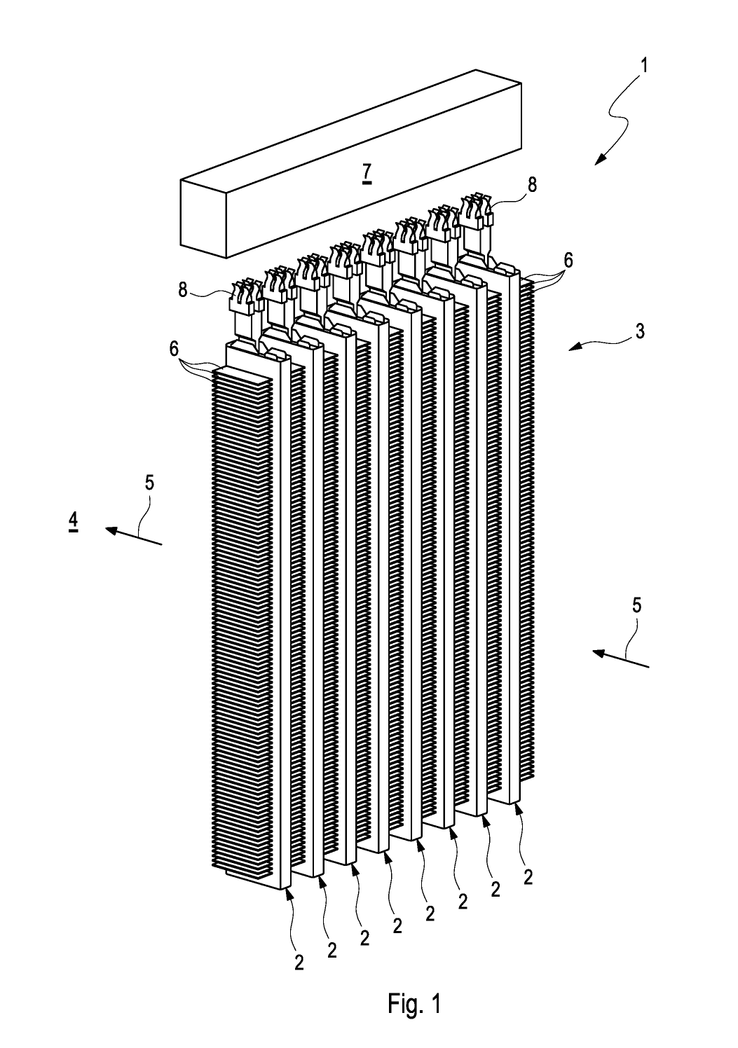

According to FIG. 1, a temperature control device 1 comprises a plurality of PTC modules 2, which are assembled into a heat transfer block 3. For this purpose, the PTC modules 2 are arranged next to each other in a heat transfer region 4, through which a fluid 5 whose temperature is to be controlled can flow. The ability of the fluid 5 to flow through the heat exchanger 4 and also the heat transfer block 3 is indicated by arrows in FIG. 1. Moreover, cooling fins 6 are provided in the heat transfer block 3, which on the one hand can have the fluid 5 flowing through them and on the other hand are connected in heat transfer manner to the PTC modules 2. The cooling fins 6 each extend between neighbouring PTC modules 2 and outwardly against the outer situated PTC modules 2.

The temperature control device 1 is furthermore outfitted with a control device 7, by means of which the PTC modules 2 can be electrically actuated. In particular, it may be provided that the control device 7 can individually activate and deactivate the individual PTC modules 2, so as to control the heating power of the heat transfer block 3. Likewise, a zone control may be realized. For the electrical connection to the control device 7, the respective PTC module 2 has corresponding electrical leads 8.

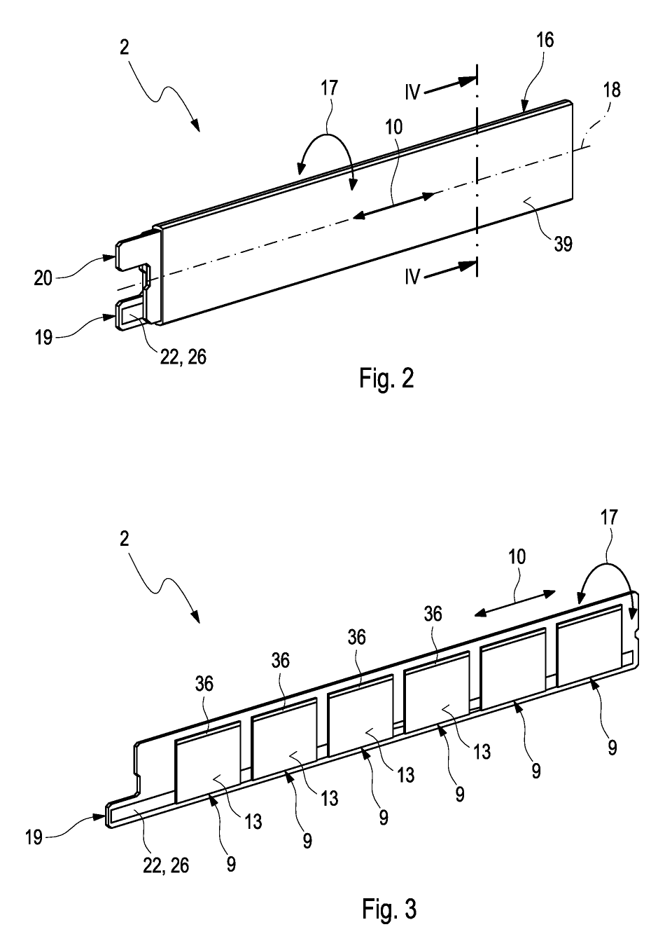

According to FIGS. 2 to 4, the respective PTC module 2 has at least one PTC element 9. Preferable are designs in which a plurality of such PTC elements 9 are provided, which are arranged in succession in a longitudinal direction 10 of the module 2, hereafter also called the module longitudinal direction 10. The PTC elements 9 consist of PTC material, and are thus PTC elements.

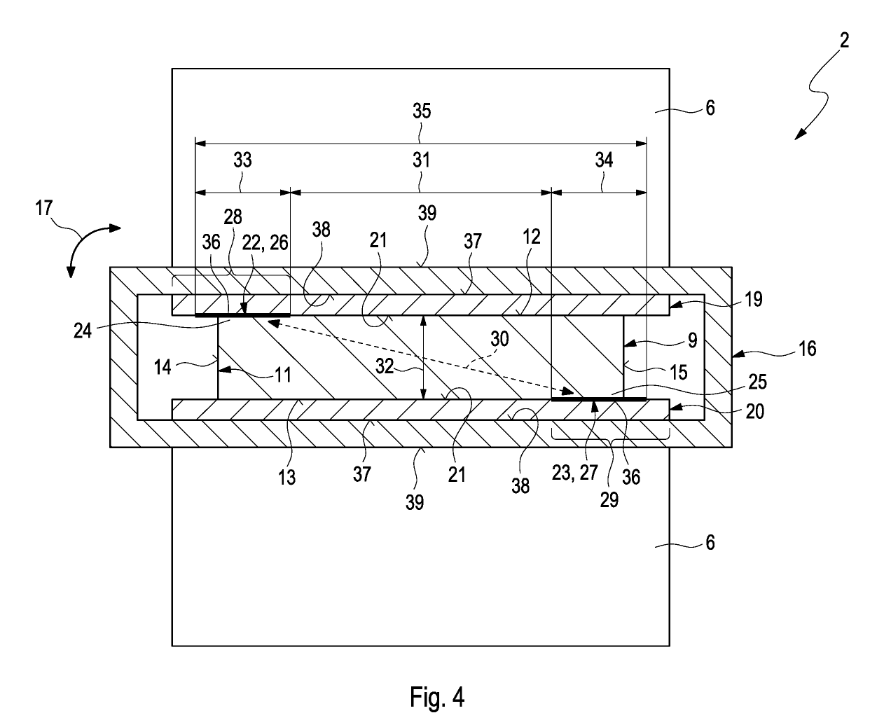

According to FIG. 4, the respective PTC element 9 has a flat element cross section 11 transversely to the module longitudinal direction 10, which runs in FIG. 4 perpendicular to the plane of the drawing, which in the preferred example shown here is rectangular in configuration. Along the module longitudinal direction 10 the respective PTC element 9 thus has two large outer surfaces 12, 13, namely, a first large outer surface 12 and a second large outer surface 13, as well as two small outer surfaces 14, 15, namely a first small outer surface 14 and a second small outer surface 15. The two large outer surfaces 12, 13 face away from each other. The two small outer surfaces 14, 15 are also facing away from each other. Moreover, the two small outer surfaces 14, 15 join the two large outer surfaces 12, 13. In the example shown, the large and small outer surfaces 12, 13, 14, 15 are configured flat each time, so that the respective PTC element 9 is also flat in configuration.

The PTC module 2 furthermore comprises an envelope body 16, which encloses the respective PTC element 9 at least in a circumferential direction 17. The circumferential direction 17 is indicated in FIGS. 2 to 4 by a double arrow and runs around the module longitudinal direction 10 or a module longitudinal centre axis 18. The envelope body 16 is expediently made of a metal, having on the one hand a good thermal conductivity and on the other hand a good electrical conductivity.

The respective PTC module 2 has electrically isolating insulator plates 19, 20, namely, a first insulator plate 19 and a second insulator plate 20. The two insulator plates 19, 20 each extend in the module longitudinal direction 10 and are each connected in heat transfer manner to one of the large outer surfaces 12, 13 of the respective PTC element 9. Expediently, the respective insulator plate 19, 20 lies flat against the entire respective large outer surface 12, 13 of the respective PTC element 9. For improved heat transfer, a thermal conduction material may be arranged between the respective large outer surface 12, 13 and a plate inner side 21 facing the respective PTC element 9, such as one in the form of a paste or in the form of a film.

Furthermore, two electrical conductors 22, 23 are provided for the electrical power supply and the actuation of the respective PTC element 9, namely, a first electrical conductor 22 and a second electrical conductor 23. The two electrical conductors 22, 23 extend each time in the module longitudinal direction 10 and are each electrically conductively connected to a contact region 24 or 25 of the respective PTC element 9. The two contact regions 24, 25, which are also called in the following the first contact region 24 and second contact region 25, are arranged on the respective PTC element 9, spaced apart from each other in the element cross section 11. In this way, the two conductors 22, 23 are also arranged on the respective PTC element 9 spaced apart from each other.

In the PTC module 2 presented here, the two electrical conductors 22, 23 are formed each time by an electrically conducting conductor coating 26, 27, which is also called in the following the first conductor coating 26 and second conductor coating 27. The first conductor coating 26 is formed on the first insulator plate 19, namely on its plate inner side 21. The second conductor coating 27 on the other hand is formed on the second insulator plate 20, likewise on its plate inner side 21. Furthermore, the arrangement of the conductor coatings 26, 27 on the respective insulator plate 19, 20 is done each time only in an edge region 28 or 29 of the respective insulator plate 19, 20. Accordingly, there is located on the first insulator plate 19 a first edge region 28, while the second insulator plate 20 has a second edge region 29. The edge regions 28, 29 are indicated in FIG. 4 by a curly brace each time. Accordingly, the first conductor coating 26 is arranged in the first edge region 28, while the second conductor coating 27 is arranged in the second edge region 29. The first edge region 28 borders on the first small outer surface 14, while the second edge region 29 borders on the second small outer surface 15. In this way, the two edge regions 28, 29 and thus also the two conductor coatings 26, 27 are arranged almost diagonally or diametrically opposite each other in the element cross section 11. This results in a substantially diagonal electrical pathway 30 inside the element cross section 11, which is taken by the electric current when the respective PTC element 9 is energized. This electrical pathway 30 is comparatively long, so that an efficient thermoelectric conversion occurs.

The two conductor coatings 26, 27 have a spacing 31 in the element cross section 11 along the large outer surfaces 12, 13. Insofar as the large outer surfaces 12, 13 are flat and run parallel to each other, as in the example shown, the spacing 31 also extends parallel to the large outer surfaces 12, 13. This spacing 31 is demonstrably larger than an element thickness 32 of the respective PTC element 9, the element thickness 32 being measured between the two large outer surfaces 12, 13. When the outer surfaces 12, 13 are flat, the element thickness 32 extends perpendicular to the large outer surfaces 12, 13. For example, the spacing 31 is at least twice as large as the element thickness 32.

Furthermore, the respective conductor coating 26 or 27 has in the element cross section 11 an effective conductor width 33 or 34, measured along the respective large outer surface 12, 13. One measures in this case only that region of the respective conductor coating 26, 27 which is directly electrically conductively connected to the respective large outer surface 12, 13 of the PTC element 9. In the example of FIG. 4, the conductor coating 26, 27 projects beyond the respective small outer surface 14, 15 along the respective insulator plate 19, 20 and thus protrudes out from the element cross section 11. This partial overhanging region of the respective conductor coating 26, 27 does not stand in direct electrical connection to the respective large outer surface 12, 13 of the PTC element 9. No such overhang is present in the example of FIG. 3.

The first conductor coating 26 has the first conductor width 23, while the second conductor coating 27 has the second conductor width 34. Expediently, the two conductor widths 33, 34 are the same size. Expediently, it may now be provided that the respective conductor width 33, 34 is less than half of an element width 35, measured between the small outer surfaces 14, 15. Preferably, the respective conductor width 33, 34 is less than a quarter of the element width 35.

Furthermore, the respective conductor width 33, 34 may be larger than the element thickness 32. This is not recognizable in the representation shown in FIG. 4, not drawn to scale, but can be seen from FIG. 3.

The respective PTC element 9 may now have an electrically conducting metal coating 36 on the respective large outer surface 12, 13, at least in the region of the respective conductor 22, 23. The respective metal coating 36 is also recognizable in FIG. 3. The respective metal coating 36 is electrically conductively connected to the respective conductor coating 26, 27. For example, the conductor coatings 26, 27 may be soldered to the metal coatings 36.

According to FIGS. 2 and 3, the two insulator plates 19, 20 extend across all the PTC elements 9, so that the two conductors 22, 23 or the two conductor coatings 26, 27 are electrically conductively connected to all the PTC elements 9. The envelope body 16 recognizable in FIG. 2 is also jointly provided for all PTC elements 9, so that it encloses all the PTC elements 9 in the circumferential direction 17.

According to FIG. 4, the thermally conductive insulator plates 19, 20 are connected in heat transfer manner to the envelope body 16. For this purpose, each time a plate outer side 37 facing away from the respective PTC element 9 is connected in sheetlike and heat transfer manner to a body inner side 38 facing toward the respective PTC element 9. This can be accomplished by a direct contact or by a thermal conduction material, which may be provided as a paste or film. The envelope body 16 according to FIGS. 1 and 4 may be connected in heat transfer manner to the cooling fins 6 at its body outer side 39 facing away from the respective PTC element 9. For example, the cooling fins 6 may be soldered to the envelope body 16.

1. A PTC module for a temperature control device, comprising:
at least one PTC element, having a flat element cross section transverse to a longitudinal direction of the PTC module, and two large outer surfaces along the longitudinal direction, facing away from each other, and two small outer surfaces facing away from each other and joining together the two large outer surfaces;
an envelope body, which encloses the at least one PTC element at least in a circumferential direction;
two electrical conductors, which extend in the longitudinal direction and are spaced apart from each other in the flat element cross section and electrically conductively connected to the at least one PTC element; and
two electrically isolating insulator plates, which extend in the longitudinal direction and each of which is connected in a heat transfer manner to one of the large outer surfaces of the at least one PTC element;
wherein each electrical conductor is formed by an electrically conducting conductor coating on a respective one of the insulator plates;
wherein the conductor coating of one of the electrical conductors is arranged on the one of the insulator plates only in a first edge region, which borders on one of the two small outer surfaces; and
wherein the conductor coating of the other of the electrical conductors is arranged on the other of the insulator plates only in a second edge region, which borders on the other of the two small outer surfaces.

2. The PTC module according to claim 1, wherein the two conductor coatings have a spacing from each other along the large outer surfaces which is larger than an element thickness of the at least one PTC element measured between the large outer surfaces.

3. The PTC module according to claim 1, wherein each conductor coating has in the element cross section a conductor width measured along a respective one of the large outer surfaces which is less than 50%, of an element width of the at least one PTC element, measured between the small outer surfaces.

4. The PTC module according to claim 1, wherein each conductor coating has in the element cross section a conductor width measured along a respective one of the large outer surfaces that is larger than an element thickness of the at least one PTC element, measured between the large outer surfaces.

5. The PTC module according to claim 1, wherein the at least one PTC element has an electrically conducting metal coating on each large outer surface at least in a region of a respective one of the conductors, which is electrically conductively connected to the conductor coating.

6. The PTC module according to claim 5, wherein each conductor coating is soldered to a respective metal coating.

7. The PTC module according to claim 1, wherein:
the at least one PTC element includes a plurality of PTC elements arranged in succession in the longitudinal direction;
the envelope body encloses all PTC elements in the circumferential direction; and
the two insulator plates extend across all PTC elements so that the two conductor coatings are electrically conductively connected to all the PTC elements.

8. The PTC module according to claim 1, wherein each insulator plate is thermally conductive and is connected in a sheet-like and heat transfer manner by a plate outer side facing away from the at least one PTC element to a body inner side of the envelope body facing toward the at least one PTC element.

9. The PTC module according to claim 1, wherein the envelope body is connected in a heat transfer manner to cooling fins at least on one body outer side facing away from the at least one PTC element.

10. A temperature control device for controlling the temperature of a fluid, comprising at least one PTC module and a control device for the electrical actuation of the at least one PTC module, each PTC module including:
at least one PTC element, having a flat element cross section transverse to a longitudinal direction of the PTC module, and two large outer surfaces along the longitudinal direction facing away from each other, and two small outer surfaces facing away from each other and joining together the two large outer surfaces;
an envelope body, which encloses the at least one PTC element at least in a circumferential direction:
two electrical conductors, which extend in the longitudinal direction and are spaced apart from each other in the flat element cross section and electrically conductively connected to the at least one PTC element; and
two electrically isolating insulator plates, which extend in the longitudinal direction and each of which is connected in a heat transfer manner to one of the large outer surfaces of the at least one PTC element
wherein each electrical conductor is formed by an electrically conducting conductor coating on a respective one of the insulator plates;
wherein the conductor coating of one of the electrical conductors is arranged on the one of the insulator plates only in a first edge region, which borders on one of the two small outer surfaces; and
wherein the conductor coating of the other of the electrical conductors is arranged on the other of the insulator plates only in a second edge region, which borders on the other of the two small outer surfaces.

11. The temperature control device according to claim 10, wherein the at least one PTC module includes a plurality of PTC modules, which are arranged alongside each other in a heat transfer region through which the fluid whose temperature is to be controlled is flowable.

12. The temperature control device according to claim 11, wherein the plurality of PTC modules form a heat transfer block, through which the fluid whose temperature is to be controlled is flowable, while the control device is mounted at a side on the heat transfer block.

13. The temperature control device according to claim 10, wherein the two conductor coatings have a spacing from each other along the large outer surfaces which is larger than an element thickness of the at least one PTC element measured between the large outer surfaces.

14. The temperature control device according to claim 10, wherein each conductor coating has in the element cross section a conductor width measured along a respective one of the large outer surfaces which is less than 50% of an element width of the at least one PTC element, measured between the small outer surfaces.

15. The temperature control device according to claim 10, wherein each conductor coating has in the element cross section a conductor width measured along a respective one of the large outer surfaces that is larger than an element thickness of the at least one PTC element, measured between the large outer surfaces.

16. The temperature control device according to claim 10, wherein the at least one PTC element has an electrically conducting metal coating on each large outer surface at least in a region of a respective one of the conductors, which is electrically conductively connected to the conductor coating.

17. The temperature control device according to claim 16, wherein each conductor coating is soldered to a respective metal coating.

18. The temperature control device according to claim 10, wherein:
the at least one PTC element includes a plurality of PTC elements arranged in succession in the longitudinal direction;
the envelope body encloses all PTC elements in the circumferential direction; and
the two insulator plates extend across all PTC elements so that the two conductor coatings are electrically conductively connected to all the PTC elements.

19. The temperature control device according to claim 10, wherein each insulator plate is thermally conductive and is connected in a sheet-like and heat transfer manner by a plate outer side facing away from the at least one PTC element to a body inner side of the envelope body facing toward the at least one PTC element.

20. A PTC module for a temperature control device, comprising:
at least one PTC element, having a flat element cross section transverse to a longitudinal direction of the PTC module, and two large outer surfaces along the longitudinal direction facing away from each other, and two small outer surfaces facing away from each other and joining together the two large outer surfaces;
an envelope body, which encloses the at least one PTC element at least in a circumferential direction;
two electrical conductors, which extend in the longitudinal direction and are spaced apart from each other in the flat element cross section and electrically conductively connected to the at least one PTC element; and
two electrically isolating insulator plates, which extend in the longitudinal direction and each of which is connected in a heat transfer manner to one of the large outer surfaces of the at least one PTC element;
wherein each electrical conductor is formed by an electrically conducting conductor coating on a respective one of the insulator plates;
wherein the conductor coating of one of the electrical conductors is arranged on the one of the insulator plates only in a first edge region, which borders on one of the two small outer surfaces;
wherein the conductor coating of the other of the electrical conductors is arranged on the other of the insulator plates only in a second edge region, which borders on the other of the two small outer surfaces; and
wherein each conductor coating has in the element cross section a conductor width measured along a respective one of the large outer surfaces which is less than 50% of an element width of the at least one PTC element, measured between the small outer surfaces, and which is larger than an element thickness of the at least one PTC element, measured between the large outer surfaces.
